(19) United States
(12) Patent Application Publication
(10) Pub. No.: US 2025/0245445 A1
(43) Pub. Date: Jul. 31, 2025

(54) ENHANCED DOMAIN-SPECIFIC LANGUAGE LEARNING MODELS

(71) Applicant: Genpact USA, Inc., New York, NY (US)

(72) Inventors: Para Hitesh, Mynampadu (IN); Prakash Selvakumar, Bangalore (IN); Varsha Rani, Gurgaon (IN); Meenakshi Sundaram Murugeshan, Bangalore (IN); Sreekanth Menon, Bangalore (IN)

(21) Appl. No.: 18/428,208

(22) Filed: Jan. 31, 2024

(51) Int. Cl. G06F 40/40; G06F 40/295; G06F 40/30

(52) U.S. Cl. CPC G06F 40/40; G06F 40/295; G06F 40/30

(57) ABSTRACT

A method and system for creating an enhanced domain-specific language learning model is disclosed. In some embodiments, the method includes training a domain language model using domain-specific data. The method includes receiving input corpus for one or more downstream tasks. The method then includes using the domain language model using the input corpus to generate a first set of embeddings, and using a pre-trained large language model (LLM) using the input corpus to generate a second set of embedding. The method further includes combining the first and second sets of embeddings to form a combined set of embeddings and perform the one or more downstream tasks using the combined set of embeddings.

### TECHNICAL FIELD

This disclosure relates to machine learning, in particular, to implementing enhanced domain-specific language learning models using business-specific sentence embeddings.

### BACKGROUND

Language models have emerged as a promising artificial intelligence (AI) trend. Some existing language models have been trained on large, diverse datasets to understand and generate language in a broad context. These large language models (LLMs) may outperform small language models due to the capability of massive data training. These models typically are general-purpose and lack the knowledge and access to specific domain contextual data. Therefore, when the language models are applied to business-specific domains with limited sample data, neither the power of LLMs attributed to large-scale data training nor efficient analysis and interpretation of domain knowledge can be leveraged. As a result, these models may not fully capture domain-specific nuances and subtleties. Such inefficiency significantly hinders the performance and practical applicability of language models.

### SUMMARY

To address the aforementioned shortcomings, a method and a system for creating an enhanced domain-specific language learning model is proposed. The method trains a domain language model using domain-specific data. The method receives input corpus for one or more downstream tasks. The method further uses the domain language model with the input corpus to generate a first set of embeddings, and uses a pre-trained large language model (LLM) with the input corpus to generate a second set of embeddings. The method further combines the first and second sets of embeddings to form a combined set of embeddings and perform the one or more downstream tasks using the combined set of embeddings.

The domain language model is trained to recognize and capture linguistic patterns, structures, and semantics of one or more specialized domains based on the domain-specific data. In some embodiments, the domain language model is a domain-specific causal language model (CLM). The method may perform statistical evaluation of the CLM by examining at least one of perplexity scores, training loss, and validation loss. In some embodiments, the pre-trained LLM is a generative pre-trained transformer (GPT) model or a bidirectional encoder representation from transformers (BERT) model.

The domain language model is domain agnostic. In some embodiments, prior to training the domain language model, the method may receive the domain-specific data from domains in at least finance, insurance, medicine, or artificial intelligence (AI) services.

To combine the first and second sets of embeddings, in some embodiments, the method may also generate the combined set of embeddings to capture and integrate both general and domain-specific knowledge respectively learned using the pre-trained LLM and the domain language model, and use the combined set of embeddings as input to the one or more downstream tasks. In some embodiments, the downstream tasks may include one or more of classification, clustering, named entity recognition (NER), and retrieval augmented generation (RAG). In some embodiments, the combined set of embeddings may be generated based on concatenation or weighted averaging. In some embodiments, the method may apply dimensionality reduction to the combined embeddings. Additionally, the method may further preprocess the input corpus.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 illustrates a block diagram of creating an enhanced domain-specific language learning model, according to some embodiments.

FIG. 2A illustrates exemplary sample agent-consumer chat data used for training an enhanced domain-specific language learning model, according to some embodiments.

FIG. 2B illustrates exemplary output from overall framework in contrast to output from a traditional approach used in a downstream task of classification, according to some embodiments.

FIG. 3 illustrates a flowchart of combining language learning models to process domain specific downstream tasks, according to some embodiments.

FIG. 4 illustrates a block diagram of an example computer system that may be used in implementing the technology described herein, according to some embodiments.

### DETAILED DESCRIPTION

The Figures (FIGs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

Recent advancements in large language models (LLMs), such as generative pre-trained transformers (GPT) and bidirectional encoder representations from transformers (BERT), have led to remarkable capabilities in understanding and generating human-like language across various tasks (e.g., classification, clustering, sentiment analysis). There is a growing demand for using these models to effectively comprehend and generate text within specific business domains such as finance, healthcare, and legal domains. However, the limited sample data in these specialized contexts poses challenges for accurately and efficiently customizing general-purpose language models to perform well.

The present disclosure proposes a system and method that combines a pre-trained LLM with a domain-specific causal language model to create an enhanced domain-specific language learning model that addresses the challenge of optimizing LLMs for domain-specific tasks. Advantageously, the present disclosure allows a tiny language model (TLM) (e.g., a causal language model) to be generated for domain-specific data, which can effectively capture and incorporate specialized knowledge and contextual nuances unique to a target domain. The hybrid approach of combining diverse embeddings from multiple language models also effectively captures and integrates both general and domain-specific knowledge to obtain comprehensive representations of input data, thereby significantly enhancing the performance and accuracy of the present system in various domain-specific tasks. The present disclosure further exhibits domain-agnostic capabilities, meaning that the framework disclosed herein can be seamlessly adapted to any domain data. This versatility ensures the effectiveness of the present framework across different industries and applications, without being limited to a specific field. In addition, the wide-ranging applicability of the present framework is beneficial in making it a valuable asset for diverse data-driven environments.

In machine learning, a pre-trained model may perform a downstream task once completing a previous task/process and use the output of the previous task as input to the downstream task. A downstream task includes applying the knowledge of the pre-trained model to a new problem. Downstreaming is important because the information gained from pre-training the model on a large dataset (e.g., LLM) can be used to enhance the performance of the same or a related model on a different, more specific job or a smaller dataset. By fine-tuning the pre-training models (e.g., LLMs) on specific downstream tasks, the performance of these tasks can be improved, thereby benefiting real-world applications.

As to downstream tasks, the present framework/system is advantageous in that it significantly improves the performance of LLMs in multiple domain-specific tasks by leveraging a combination of pre-trained LLMs and domain-specific causal language models, resulting in accurate and comprehensive representations of input data. The present framework is designed to facilitate a thorough evaluation of numerous downstream tasks, ensuring optimal performance in diverse applications. By analyzing the impact of the downstream tasks, the present system guides users in making informed decisions and tailoring/customizing the framework to their specific needs. This comprehensive assessment approach not only enhances the overall efficiency but also contributes to the continuous improvement of the present system in real-world scenarios.

The use of an enhanced domain-specific language learning model can alleviate problems typically encountered by a computing system that may employ a conventional programming solution, such as running out of allotted processing capacity and/or time, running out of memory, excessive power consumption, etc. This is accomplished in part, by avoiding an exhaustive exploration of all the potentially feasible algorithms because the number of such algorithms can grow exponentially, and the application of all such algorithms to the domain-specific data can become computationally prohibitive even for the largest and fastest known computing systems. Rather than performing such exhaustive exploration, the enhanced domain-specific language learning model described herein learns patterns that are generally more important and accurate than others from experience. Using these patterns, the enhanced domain-specific language learning model can isolate the algorithms that are likely more relevant to domain-specific data, where such algorithms can be applied efficiently. In particular, the models and algorithms described herein can be applied without exceeding the available computing resources in terms of memory capacity; processing capacity (e.g., specified as million instructions per second (MIPS)); and processing time, specified as actual time (e.g., in minutes, seconds) and/or as CPU time (e.g., in microseconds, seconds).

### System Implementation

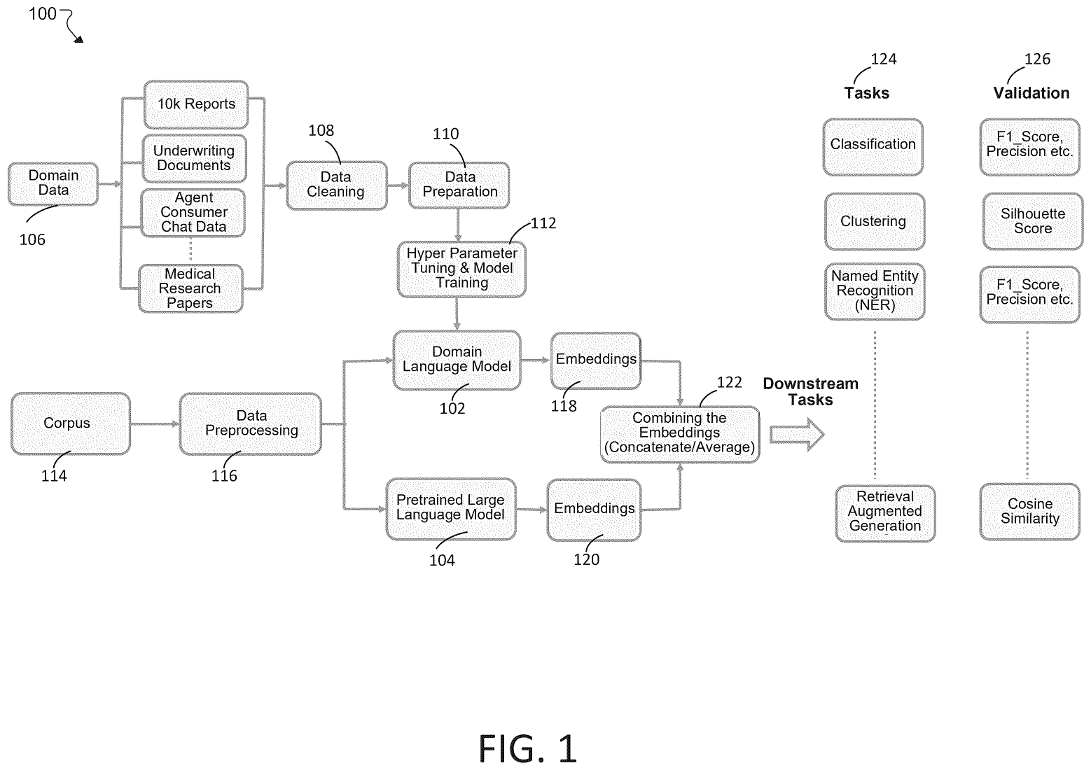

FIG. 1 illustrates a block diagram 100 of implementing an enhanced domain-specific language learning model, according to some embodiments. The present disclosure describes a system and method that combines the strengths of a pre-trained LLM with a domain-specific causal language model, enhancing performance through advanced embedding techniques, data preprocessing, and dimensionality reduction. Additionally, the present framework is designed to be task-agnostic, accommodating a wide range of applications such as classification, clustering, named entity recognition (NER), and retrieval augmented generation A robust evaluation mechanism is further integrated to refine techniques and ensure optimal performance, including statistical evaluation of a causal language model (CLM) and evaluation of downstream tasks.

As discussed above, the technical problem lies in the limited performance and applicability of existing language models in specific domains due to their inability to capture domain-specific nuances with limited sample data. The present disclosure proposes a novel approach for domain adaptation of current language models to overcome this technical problem, the effectiveness and practicality of which in real-world business scenarios are also evaluated and described herein.

In the illustrated embodiment of FIG. 1, a domain language model 102 and a pre-trained large language model (LLM) 104 are combined to solve complex problems in specific domains, in particular, to process domain specific downstream tasks. Domain data or domain-specific data can include many types of data. In the example of FIG. 1, domain data 106 includes financial data like annual 10k reports, underwriting documents used in insurance, agent consumer chat data, medical research papers, etc. Domain data are significantly different in conversation and language styles. Even human beings need a certain level of training and experience to understand different fields, roles, and tasks in different domain data. A language model is expected to perform well on test data when this model is trained to learn from the training data in the same domain. However, it is difficult to customize and adapt the language model to scenarios involving different domains.

In addition to the heterogeneity of domain data, a pre-trained model (e.g., LLM 104) may not obtain the in-depth and accurate domain knowledge in real time to perform efficient literature analysis and complex data interpretation. More importantly, domain data 106 may not be publicly available and used as the training data of an LLM since many domain knowledge resources include core competitive information that cannot be leaked to a general-purpose LLM. Therefore, the pre-trained LLM 104 has to be injected with specific domain contextual data and augmented by domain-specific knowledge to achieve optimized performance.

Because updating knowledge in LLMs is challenging due to computational costs and the need for efficient optimization strategies, in the present framework, domain language model 102 is built to add a layer to pre-trained LLM 104 to efficiently process specific data in specific domains.

### Training Domain Language Model

As depicted in FIG. 1, the present framework excels in its ability to ingest diverse domain-specific data 106, and this adaptability ensures the applicability of the present framework across a broad spectrum of specialized domains. Domain data 106 is then processed and used to train and build domain language model 102. In some embodiments, the processing may include data cleaning 108, data preparation 110, and hyperparameter tuning & model training 112.

Data cleaning 108 is used to detect and correct inaccurate or irrelevant data, for example, removing redundant data or modifying incomplete data. Data preparation 110 includes collecting, combining, structuring, and organizing domain data so it can be used in domain language model 102. The components of data preparation 110 may include data preprocessing, profiling, validation, transformation, etc. Data cleaning 108 and data preparation 110 can vary from domain to domain. For example, data from a specific domain may be transformed into a particular format for model training. According to the customized methods of cleaning and preparation, 10k reports may be tokenized and converted into a particular format, while continuous agent-consumer chat data may be parsed and further segregated and classify each data unit (e.g., to identify each data unit belonging to a consumer or agent) before format conversion. A small data unit or token results from the process of tokenization that breaks down the text data.

Hyperparameter tuning & model training 112 may significantly impact model performance. Hyperparameter tuning includes finding an optimal set of hyperparameters for domain language model 102. For example, hyperparameter tuning may be used to find the optimal values for parameters such as “learning_rate,” “dropout_rate,” and “optimizer” that are critical in training a language model. In some embodiments, hyperparameter tuning can also be applied based on various batch sizes, different scheduling algorithms (e.g., linear and polynomial decay), varying context length and epochs, etc. Depending on the characteristics (e.g., type, size) of domain data 106, hyperparameter tuning can be conducted via grid search, random search, Bayesian optimization, genetic algorithms, etc.

As to model training, the domain data corresponding to the training dataset is supplied to domain language model 102, and outputs from model 102 are obtained. For example, model 102 under training may infer some causal relationships and associated algorithms. The outputs are compared with the labeled outputs and error signals provided to model 102 under training to determine whether the labeled outputs and the obtained outputs are different. In response, hyperparameter tuning and adjustment may be performed. For example, a training loss or a loss function may be computed, and weights and/or activation functions associated with model 102 may be adjusted accordingly. This process is repeated for a specified number of iterations or until the numbers and/or size of the error falls below a specified threshold. At that time, domain language model 102 is assumed to be trained, and the model training moves to a testing phase. In the testing phase, a similar process is performed but with test data (instead of training data) as input to model 102, and a validation loss may be computed. If the validation loss shows that error rates fall below a specified threshold, domain language model 102 is fully trained. Otherwise, a re-training process is initiated.

In some embodiments, domain language model 102 is a domain-specific causal language model (CLM). CLM is an autoregressive method that can predict the next token (e.g., word) in a sequence given a previous token. The present framework trains this model to comprehensively understand and capture the nuances and intricacies of the specialized domain. When training the CLM in 112, statistical evaluation of the CLM may be conducted to assess its performance and effectiveness. Various metrics such as perplexity scores, training loss, and/or validation loss, may be employed in evaluating the CLM. A perplexity score may gauge how well the prediction is, e.g., by quantifying the randomness and uncertainty of the next token inferred and generated by the model. The training loss (e.g., a loss function) represents how well the model fits the training data, and the validation loss indicates how well a model is performing. These metrics help assess the model's performance and guide improvements.

The present system can successfully train domain language model 102. In practical experiments, the results indicate that the CLM described herein has achieved a proper balance between fitting the training data and well-generalizing to unseen validation data. The test scores obtained from the experiments (e.g., perplexity score) also suggest that the present CLM model is capable of generating coherent and contextually relevant responses, making it suitable for various natural language processing tasks.

### Pre-Trained Large Language Model

On the other hand, to leverage the extensive knowledge base and linguistic capabilities, the present framework acquires a pre-trained LLM 104. A pre-trained LLM is generally an open-source data model built upon publicly available data sets, such as GPT and BERT. One skilled in the art should recognize other open-source LLMs may be used as the pre-trained LLM to implement the functionalities described herein.

Pre-trained LLMs have led to impressive gains on natural language processing tasks; however, most LLMs are pre-trained on large, general domain corpora to learn linguistic patterns, structures, and semantics. When domain-specific data is under-represented and/or from limited sources, LLMs cannot learn for domain-specific tasks and provide definitive answers. Due to the ability of pre-trained LLMs to learn universal language representations from large-scale data in an unsupervised manner, LLMs can be beneficial for many downstream tasks, avoiding training new models from scratch. Generally scaling up pre-trained language models (e.g., in the model or data size) may enhance model capacity for downstream tasks, but adapting an LLM to downstream tasks needs vast amounts of high-quality, task-specific data. Therefore, it is advantageous to combine domain language model 102 and pre-trained LLM 104 to leverage the effective domain-specific data processing ability and powerful language processing ability of the respective model as proposed herein.

### Embedding Generation

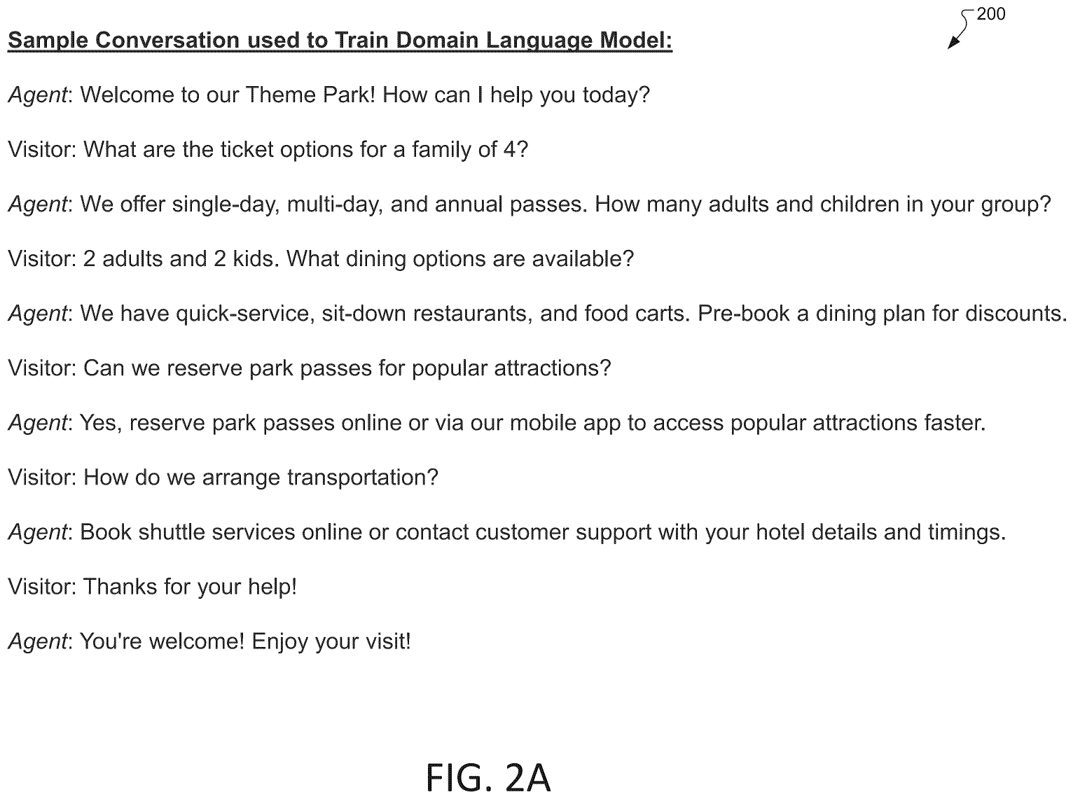

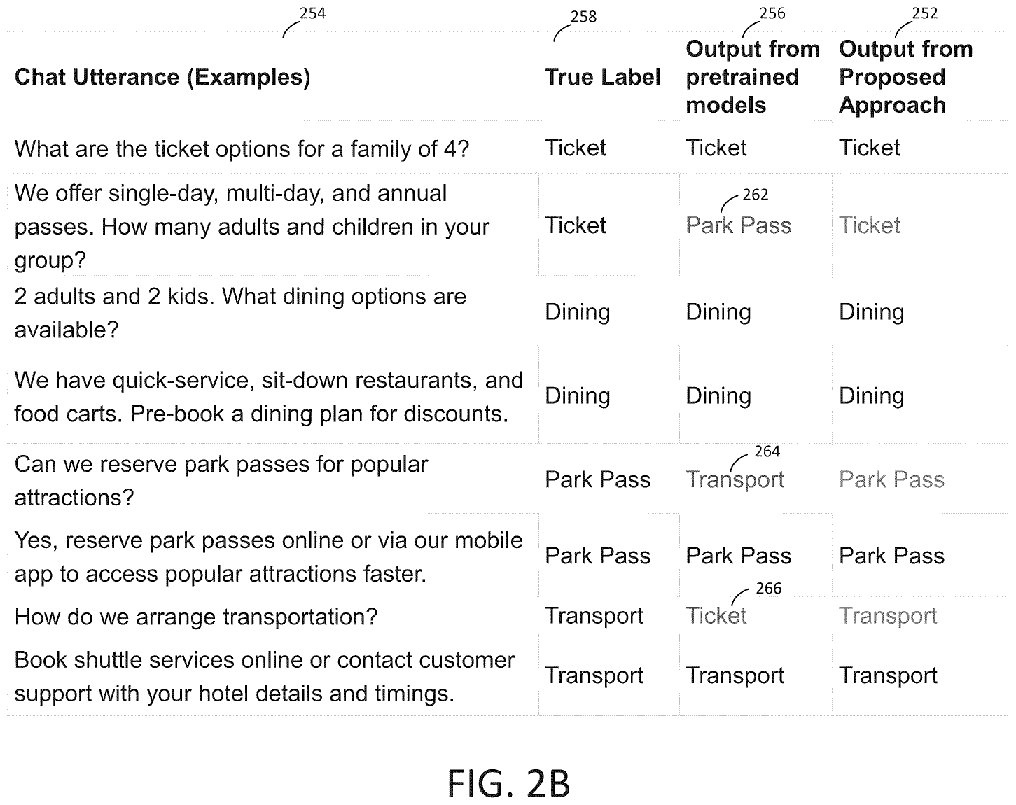

In FIG. 1, corpus 114 is inputted to domain language model 102 and pre-trained LLM 104 to output embeddings. A corpus is a set of text used to train an ML model. Here, corpus 114 can be text (e.g., a sentence) that serves as context for understanding and processing. In some embodiments, corpus 114 may include an additional sentence or query (e.g., a prompt) to provide a task explanation. An example corpus is shown in FIGS. 2A and 2B. The present framework allows each corpus 114 (e.g., input sentence) to undergo meticulous pre-processing in 116. In some embodiments, techniques such as tokenization, stemming, and stop word removal are applied to optimize the data for subsequent analysis and embedding generation. Tokenization is the process of breaking down text pieces into small data units or tokens. Stemming is the process of reducing words to their word stem, base or root form. For example, words, words “retrieve,” “retrieved,” “retrieval,” and “retrieving” can all be stemmed to the root “retriev.”

The pre-processed corpus data (e.g., input sentence) is then passed to domain language model 102 to generate embeddings 118. The pre-processed corpus data is also passed to pre-trained LLM 104 to generate embeddings 120. An embedding is a numeric representation (e.g., vector) of objects and relationships between the objects included in the input corpus data. In some embodiments, domain language model 102, for example, a domain-specific causal language model, generates embeddings 118 based on the learning from domain-specific data, while the general-purposed pre-trained LLM 104 generates embeddings 120 based on the learning from general data included in the input sentences.

Embeddings are generated for each input sentence from both models 102, and 104 based on the learning of linguistic patterns, structures, and semantics from the corpus data (e.g., sentences). For example, domain language model 102 may map words and phrases in the entire domain data to embeddings 118 (e.g., vector embeddings). An embedding can capture the semantics of the input corpus data by categorizing semantically similar inputs together in the embedding space. The embeddings (e.g., vector embeddings), which quantify the semantic similarity between categories, can also be passed to other models. For example, embeddings 118 generated from domain language model 102 can be incorporated with pre-trained LLM 104 and embedding 120. In such cases, the models can share learnings across similar items rather than treating them as two unique categories. For this reason, embeddings can be used to accurately represent sparse data (e.g., a limited amount of domain data), and improve the downstream task performance.

It should be noted that domain data 106 is used only to train domain language model 102, while corpus data 114 is used for downstream task implementation, in particular, for generating combined embeddings using domain language model 102 (trained based on domain data 106) and pre-trained LLM 104 for downstream tasks in 124.

### Combining Embeddings for Operation of Downstream Tasks

As shown in FIG. 1, once embeddings 118 representing domain-specific data and embeddings 120 representing general data are generated, the present framework combines these embeddings in 122. This results in a hybrid embedding that effectively encapsulates both domain-specific knowledge from domain language model 102 and general knowledge from pre-trained LLM 104.

Various approaches may be applied to construct hybrid embeddings based on combining domain-based embeddings and embeddings from a pretrained model. The present framework may combine the embeddings 118, and 120 from both models through concatenation or addition operations (e.g., concatenation or weighted averaging). In some embodiments, the present framework may apply the weighted average approach in specific use cases based on the superior performance of the weighted average method in capturing both the fine-grained domain-specific information and the broader semantic understanding from the retrained model-based embeddings. By employing this approach, the present system can create an effective and contextually relevant representation, which is advantageous to targeted tasks and applications. For example, the present framework may increase the weights associated with domain-specific data (e.g., medical terms) when generating the hybrid embeddings to indicate the significant insights learned from these medical terms by domain language model 102. Thus, the performance of subsequent downstream tasks can be significantly improved when inputted with the hybrid embeddings that catch the entire representation of input text/sentences.

A downstream task is a supervised learning task that utilizes one or more pre-trained models or components. In FIG. 1, a downstream task depends on the output of both domain language model 102 and pre-trained LLM 104. In some embodiments, before serving the hybrid/combined embeddings as input to a downstream task, the present platform may apply dimensionality reduction to combined embeddings to minimize the computational complexity while retaining essential information. The dimensionality reduction may include principal component analysis (PCA), t-distributed stochastic neighbor embedding (t-SNE), etc.

The reduced-dimension hybrid embeddings find application in various downstream tasks, which apply the knowledge learned and tuned from models 102 and 104 to perform a task without training a new model. Advantageously, the task-agnostic nature of the present system empowers it to handle a multitude of downstream tasks. As shown in FIG. 1, the downstream tasks 124 may include classification, clustering, NER, topic modeling, retrieval augmented generation etc., where the enhanced hybrid embeddings can be effectively deployed for specific tasks within a domain. For example, conversation data between agents and users booking tickets for theme parks and restaurants (as described below in FIG. 2A) may be used for a multi-class downstream classification task. The objective of this classification task is to categorize the conversation into distint service categories that an end-user is seeking. The present approach leverages domain knowledge from the conversation corpus, resulting in effective performance on classification (including categorizing less frequently occurring categories).

The present system allows the integration of downstream tasks with a retrieval augmented generation (RAG) framework, to infer and retrieve relevant information from external sources, without fine-tuning model parameters. The RAG framework, when leveraging the capabilities of pre-trained embeddings and domain-enriched embeddings, can achieve enhanced retrieval performance due to the incorporation of domain context within the embeddings. Hybrid embeddings exhibit higher magnitude for domain-related entities and text, resulting in more accurate retrieval of answers from the data. Furthermore, these embeddings benefit from the semantic learning provided by dense methods, contributing to their overall effectiveness.

An integral aspect of the present framework is its comprehensive evaluation mechanism. Tailored for each task, this mechanism systematically scores techniques, enabling iterative refinement for optimal performance. In some embodiments, for each downstream task, appropriate evaluation metrics 126 are utilized. For example, classification tasks may be evaluated using the F1 score, precision, and other relevant measures, ensuring a comprehensive assessment of the performance of the present framework. The performance of the present framework can be seen from an example of a classification downstream task in FIGS. 2A-2B.

### Downstream Classification Example

FIG. 2A illustrates an example sample conversation 200 between an AI agent and a consumer (e.g., a visitor to a theme park). This may be data collected from a particular chatbot application associated with a particular organization (e.g., the theme park), which is only available in a limited scope and thus is specific to that domain. The present system uses this sample agent-consumer interaction chat data to train domain language model 102 in FIG. 1. Conversation 200 is generally in the form of question-answers with some prompts to help the visitor book park ticket(s) and provide information for park transportation. Domain language model 102 (e.g., a CLM) needs to effectively understand the linguistic and semantic meaning of data units of each sentence of the conversation to generate embeddings that accurately represent each data unit in order to perform well in subsequent downstream tasks. As discussed above, domain language model 102 is integrated with pre-trained LLM 104 to create an enhanced domain-specific language learning model, and the embeddings from each model 102, and 104 are combined and outputted to enhance the performance of downstream tasks.

FIG. 2B illustrates the output from overall framework in contrast to output from a traditional approach used in a downstream task of classification. The present approach generates output in column 252 based on the sample conversation data shown in FIG. 2A and in column 254. As compared to the output from existing pre-trained models (i.e., pre-trained GPT-2) in column 256, the output from the present approach in 252 matches all true labels in column 258 while the output in 256 has inconsistency in entries 260, 262, and 264. In this example, the present framework used 4000 samples in a training dataset and 1000 samples in a testing data set, and an F1 score was used to measure the model's accuracy and evaluate the classification task. The proposed approach effectively tailors broad, universally trained LLMs to operate optimally within a specific domain.

### Flowchart

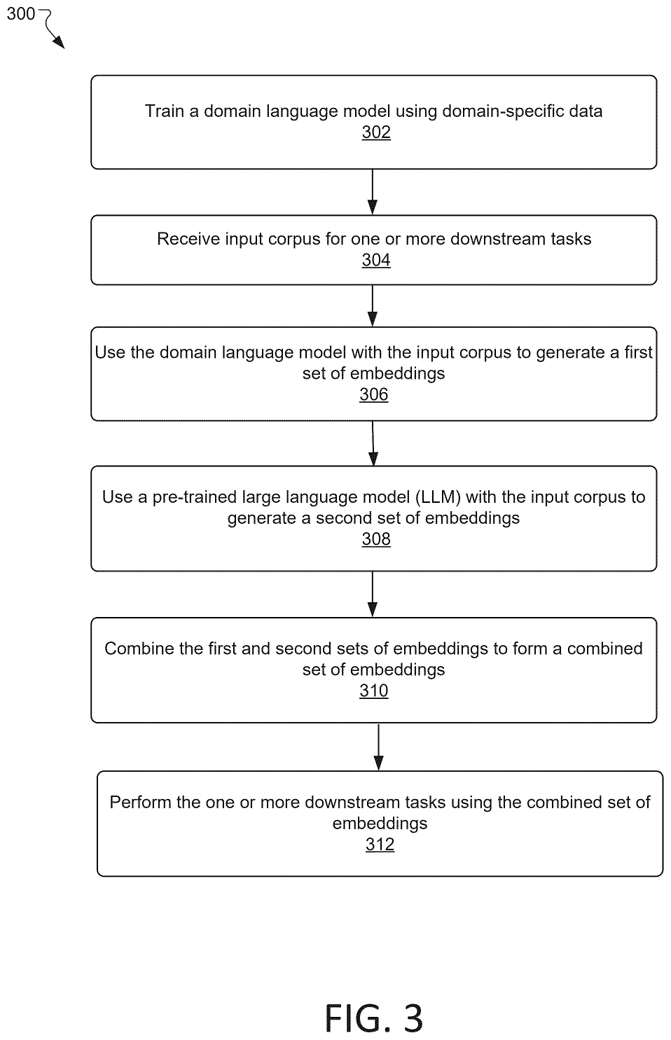

FIG. 3 illustrates a flowchart 300 of combining language learning models to process domain specific downstream tasks, according to some embodiments. At step 302, the present framework receives domain or domain-specific data and trains a domain language model using the domain-specific data, for example, based on data cleaning, data preparation, and hyperparameter tuning. In some embodiments, the domain-specific language learning model may be a domain-specific causal language model (CLM). The domain-specific data may be related to domains in finance, insurance, medicine, or artificial intelligence (AI) services. The domain language model is trained to recognize and capture linguistic patterns, structures, and semantics of one or more specialized domains based on the domain-specific data. The innovative technology disclosed herein exhibits domain-agnostic capabilities, allowing it to seamlessly adapt to any domain data. This versatility ensures its effectiveness across various industries and applications, without being limited to a specific field.

At step 304, the present framework receives input corpus for one or more downstream tasks, for example, an agent-consumer interactive chat as shown in FIG. 2A. At step 306, the present framework uses the domain language model with the input corpus to generate a first set of embeddings. At step 308, the present framework uses a pre-trained large language model (LLM) with the input corpus to generate a second set of embeddings. In some embodiments, the pre-trained LLM can be a GPT or BERT model. In some embodiments, the input corpus is pre-processed (e.g., tokenization, stemming, and stop word removal) are applied to optimize the data for subsequent analysis and embedding generation.

At step 310, the present platform combines the first and second sets of embeddings to form a combined set of embeddings, for example, based on concatenation and weight averaging. This hybrid approach of combining diverse embeddings from multiple language models effectively captures and integrates both general and domain-specific knowledge, resulting in a more comprehensive representation of input data and significantly enhancing the performance and accuracy of the present platform in various domain-specific tasks. At step 312, the present platform performs the one or more downstream tasks using the combined set of embeddings. The downstream tasks may include one or more of classification, clustering, named entity recognition (NER), and retrieval augmented generation (RAG).

### Computer Implementation

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used, and/or functional programming languages can be used. Electrical memory, such as flash-based memory, can be used.

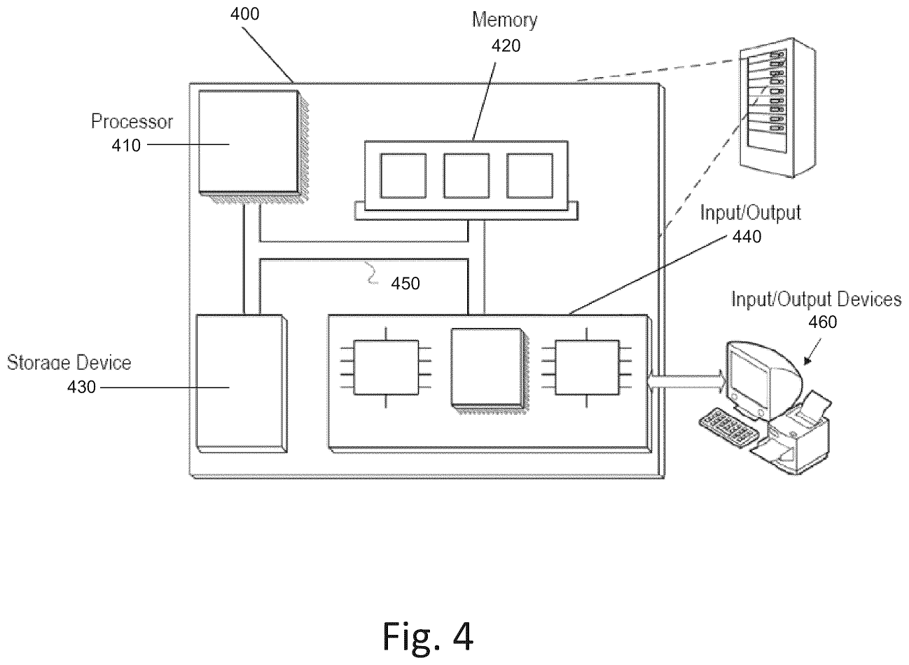

FIG. 4 is a block diagram of an example computer system 400 that may be used in implementing the technology described herein. General-purpose computers, network appliances, mobile devices, or other electronic systems may also include at least portions of the system 400. The system 400 includes a processor 410, a memory 420, a storage device 430, and an input/output device 440. Each of the components 410, 420, 430, and 440 may be interconnected, for example, using a system bus 450. The processor 410 is capable of processing instructions for execution within the system 400. In some implementations, the processor 410 is single-threaded. In some implementations, the processor 410 is a multi-threaded processor. The processor 410 is capable of processing instructions stored in the memory 420 or on the storage device 430.

Memory 420 stores information within the system 400. In some implementations, the memory 420 is a non-transitory computer-readable medium. In some implementations, the memory 420 is a volatile memory unit. In some implementations, the memory 420 is a non-volatile memory unit.

The storage device 430 is capable of providing mass storage for the system 400. In some implementations, the storage device 430 is a non-transitory computer-readable medium. In various implementations, the storage device 430 may include, for example, a hard disk device, an optical disk device, a solid-state drive, a flash drive, or some other large-capacity storage device. For example, the storage device may store long-term data (e.g., database data, file system data, etc.). The input/output device 440 provides input/output operations for the system 400. In some implementations, the input/output device 440 may include one or more network interface devices, e.g., an Ethernet card, a serial communication device, e.g., an RS-232 port, and/or a wireless interface device, e.g., an 402.11 card, a 3G wireless modem, or a 4G wireless modem. In some implementations, the input/output device may include driver devices configured to receive input data and send output data to other input/output devices, e.g., keyboard, printer, and display devices 460. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, executable code, or other instructions stored in a non-transitory computer-readable medium. The storage device 430 may be implemented in a distributed way over a network, such as a server farm or a set of widely distributed servers, or may be implemented in a single computing device.

Although an example processing system has been described in FIG. 4, embodiments of the subject matter, functional operations, and processes described in this specification can be implemented in other types of digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media, and memory devices, including way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein are for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements. Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith

What is claimed is:

1. A method for creating an enhanced domain-specific language learning model, the method comprising:
training a domain language model using domain-specific data;
receiving input corpus for one or more downstream tasks;
using the domain language model with the input corpus to generate a first set of embeddings;
using a pre-trained large language model (LLM) with the input corpus to generate a second set of embeddings;
combining the first and second sets of embeddings to form a combined set of embeddings; and
performing the one or more downstream tasks using the combined set of embeddings.

2. The method of claim 1, wherein the domain language model is trained to recognize and capture linguistic patterns, structures, and semantics of one or more specialized domains based on the domain-specific data, and wherein the domain language model is a domain-specific causal language model (CLM).

3. The method of claim 2, further comprising performing statistical evaluation of the CLM by examining at least one of perplexity scores, training loss, and validation loss.

4. The method of claim 1, wherein the domain language model is domain agnostic, and wherein prior to training the domain language model, the method further comprises:
receiving the domain-specific data from domains in at least finance, insurance, medicine, or artificial intelligence (AI) services.

5. The method of claim 1, wherein the pre-trained LLM is a generative pre-trained transformer (GPT) model or a bidirectional encoder representation from transformers (BERT) model.

6. The method of claim 1, wherein combining the first and second sets of embeddings comprises:
generating the combined set of embeddings to capture and integrate both general and domain-specific knowledge respectively learned using the pre-trained LLM and the domain language model; and
using the combined set of embeddings as input to the one or more downstream tasks.

7. The method of claim 6, wherein the downstream tasks include one or more of classification, clustering, named entity recognition (NER), and retrieval augmented generation (RAG).

8. The method of claim 6, wherein the combined set of embeddings are generated based on concatenation or weighted averaging.

9. The method of claim 6, further comprising applying dimensionality reduction to the combined embeddings.

10. The method of claim 1, further comprising preprocessing the input corpus.

11. A system for creating an enhanced domain-specific language learning model, the system comprising:
a processor; and
a memory in communication with the processor and comprising instructions which, when executed by the processor, program the processor to:
train a domain language model using domain-specific data;
receive input corpus for one or more downstream tasks;
use the domain language model using the input corpus to generate a first set of embeddings;
use a pre-trained large language model (LLM) using the input corpus to generate a second set of embeddings;
combine the first and second sets of embeddings to form a combined set of embeddings; and
perform the one or more downstream tasks using the combined set of embeddings.

12. The system of claim 11, wherein the domain language model is trained to recognize and capture linguistic patterns, structures, and semantics of one or more specialized domains based on the domain-specific data, and wherein the domain language model is a domain-specific causal language model (CLM).

13. The system of claim 12, wherein the instructions further program the processor to:
perform statistical evaluation of the CLM by examining at least one of perplexity scores, training loss, and validation loss.

14. The system of claim 11, wherein the domain language model is domain agnostic, and wherein prior to training the domain language model, the instructions further program the processor to:
receive the domain-specific data from domains in at least finance, insurance, medicine, or artificial intelligence (AI) services.

15. The system of claim 11, wherein the pre-trained LLM is a generative pre-trained transformer (GPT) model or a bidirectional encoder representation from transformers (BERT) model.

16. The system of claim 11, wherein to combine the first and second sets of embeddings to form the combined set of embeddings, the instructions further program the processor to:
generate the combined set of embeddings to capture and integrate both general and domain-specific knowledge respectively learned using the pre-trained LLM and the domain language model; and
use the combined set of embeddings as input to the one or more downstream tasks.

17. The system of claim 16, wherein the downstream tasks include one or more of classification, clustering, named entity recognition (NER), and retrieval augmented generation.

18. The system of claim 16, wherein the combined set of embeddings are generated based on concatenation or weighted averaging.

19. The system of claim 16, wherein the instructions further program the processor to apply dimensionality reduction to the combined embeddings.

20. A computer program product for creating an enhanced domain-specific language learning model, the computer program product comprising a non-transitory computer-readable medium having computer readable program code stored thereon, the computer readable program code configured to:
train a domain language model using domain-specific data;
receive input corpus for one or more downstream tasks;
use the domain language model with the input corpus to generate a first set of embeddings;
use a pre-trained large language model (LLM) with the input corpus to generate a second set of embeddings;
combine the first and second sets of embeddings to form a combined set of embeddings; and
perform the one or more downstream tasks using the combined set of embeddings.
